(19) United States
(12) Patent Application Publication
(10) Pub. No.: US 2004/0086253 A1
(43) Pub. Date: May 6, 2004

(54) Fiberoptic harness for distribution of signals with stable phase delay

(76) Inventors: Thomas William Karras, Berwyn, PA (US); Peter David Stansburg Parkinson, Wayne, PA (US)

Correspondence Address: DUANE MORRIS LLP, 100 COLLEGE ROAD WEST, SUITE 100, PRINCETON, NJ, 08540-6604, US

(21) Appl. No.: 10/289,069

(22) Filed: Nov. 6, 2002

(51) Int. Cl. G02B 6/00

(52) U.S. Cl. 385/136

(57) ABSTRACT

A spacecraft or other vehicle includes a sources and sinks of light information signals. Light transmission optical fibers are required to exhibit low change in phase delay. Temperature compensated optical fibers provide superior performance by comparison with coaxial cables, but when restrained, the optical fibers do not perform as well. According to an aspect of the invention, the optical fibers are restrained against lateral movement by fixing rings attached to the vehicle body. The fiber-accommodating apertures in the restraining rings are dimensioned to allow the optical fibers to move axially, to rotate andor to expand laterally. The fibers may be in “bundles.”

### FIELD OF THE INVENTION

This invention relates to distribution of signals on physically restrained optical fibers with stable phase delay characteristics, especially in spacecraft applications.

### BACKGROUND OF THE INVENTION

Many sophisticated signal processing applications require plural, related signals which are in particular phase relationships with each other. One such application is in phased-array antennas, where the signals coupled to or from the elements of the antenna must be predictable and controllable in order to direct the beam(s) of the phased-array antenna in the selected directions. The phase control of the signal distribution must remain stable under various environmental conditions, including temperature and aging. In some applications, coaxial transmission lines or cables are used to distribute radio-frequency (RF) signals to and from the antenna elements or other devices which are in communication.

Those skilled in the art know that coaxial cables (coax) include a type of electromagnetic transmission line including an elongated electrically conductive outer conductor defining a central aperture, and a center conductor extending coaxially through the central aperture. While some coaxial cables intended for short runs may have their center conductors supported only at the ends of the run, so that the stiffness of the center conductor supports it through the entire run, most applications, including those involving curved dispositions, are such that internal supports are required to hold the center conductor coaxial with the outer conductor. These supports take various forms, possibly the most common of which is a dielectric filler material lying between the center and outer conductors. Such filler may be in the form of a foamed material or a solid plastic. In some low-loss applications, the support may be in the form of dielectric rings or Wyes surrounding the center conductor, and bearing on the exterior of the inner conductor and the interior of the outer conductor. Such supports, however, undesirably allow the center conductor to move away from a coaxial condition relative to the outer conductor in curved regions of the cable.

A run of large-diameter rigid coaxial cable is much like a run of pipe, in that no covering or protection is required. However, flexible coaxial cables are made with outer conductors which are formed from conductive wire braid, wound conductive foil, or both. These outer conductor structures are comparatively flimsy. In addition, the braid or wound-foil outer conductors allow ingress of moisture, which ingress might adversely affect the electrical characteristics. For mechanical protection and to prevent ingress of moisture, coaxial cables are often provided with a protective outer covering, such as a coating of vinyl or other plastic. Such protective outer coverings do not affect the electrical performance of the coaxial transmission line, but add to the overall diameter of the individual coaxial cable, to its stiffness, and to its mass. It will be understood that the actual electromagnetic transmission-line portion of a coaxial cable occurs or exists in that region which lies roughly between the outer surface of the center conductor and the inner surface of the outer conductor.

While effective and widely used, coaxial cables have some disadvantages, among which are significant losses, especially at RF frequencies lying in the gigahertz regions, and significant mass (and corresponding weight). The mass of a single coaxial cable may not be individually great, but when large numbers of signals are to be distributed, especially over long distances, the mass of a bundle of cables may be undesirable, especially in space vehicles. This cumulative mass results in the tendency to use small-diameter coaxial cables for applications in which bundles of cables are to be used. The use of small-diameter cables, in turn, tends to increase the signal losses.

In addition, bundles of coaxial cables tend to be quite rigid, even if the individual cables are flexible. Such bundles of coaxial cables are often found in array antennas. The routing of a bundle of coaxial cable through or over a vehicle is not an insignificant task, since the electrical lengths of the coaxial cables must often be maintained equal, notwithstanding the curving of the bundle around corners. Such bundles can only with great difficulty be routed along a path including two relatively moving elements, such as along an antenna mast rotatably affixed to to a vehicle body, and even when so routed, the coaxial cables tend to be subject to differential phase shift between coaxial cables near the center of rotation of the joint and those more distant, which flex less. Also, when exposed to temperature variations, those coaxial cables on the exterior of a bundle tend to expand or contract earlier than the coaxial cables which are more interior to the bundle. The phase delay of electrical signals passing through such cables can be profoundly affected by even the minor variations in the resulting stress and strain in the outer and inner conductors, and in the fill lying therebetween. These mechanical considerations make electrical coaxial cables vulnerable to varying temperatures and the vagaries of common support approaches.

The disadvantages of coaxial cables for RF signal distribution have led to the use of optical fiber communications in some RF signal distribution applications. Optical fibers tend to have significantly greater bandwidth than coaxial cables, and also tend to have lower losses per unit length. In addition, optical fibers tend to be much smaller and morer flexible than coaxial cables. Some optical fibers are compensated for temperature variations, and have a low temperature coefficient of delay, which is related to phase performance. Thus, optical fibers tend to be superior for applications requiring transmission of the signals over plural paths. Optical fibers are ordinarily provided with protective outer coverings for mechanical protection.

Improved arrangements are desired for routing optical fiber cables.

### SUMMARY OF THE INVENTION

A vehicle according to an aspect of the invention includes a structural body, a first source of light information signal mounted to the body, and a first sink of light information signal mounted to the body at a location remote from the first source of light information. The source and sink may be part of a communication system, or part of an array antenna. An optical fiber light transmission path extends from the first source of light information signal to the first sink of light information signal, for carrying the information signal from the first source to the first sink. If the optical fiber light transmission path were not restrained, it might assume a stance which routes the optical fiber light transmission path through a region in which its presence might interfere with other devices. A fiber restraint is mechanically coupled to the vehicle body at a selected location to which the optical fiber light transmission path should be restrained, the fiber restraint substantially surrounding the optical fiber light transmission path in such a fashion that the optical fiber light transmission path is restrained against large lateral movement, but not against at least one of longitudinal movement, rotation, or lateral expansion. The stress and strain applied to the fibers is thereby minimized, even in the face of rapid temperature variations.

In a particular embodiment of the invention, the restraint is in the form of a ring having a body defining an interior clearance aperture sufficient to allow the optical fiber to slide therethrough longitudinally without significant resistance, but wherein the presence of the body of the ring limits large lateral movement of the optical fiber. Plural rings may accommodate plural optical fibers. The ring may be generally round. The ring may be split so that the optical fiber can be easily laid therein, and the split may be closed by a closing member to prevent any possible release of the fiber(s). The closing member may be movable relative to the remainder of the ring by virtue of a hinge with a pin or a flexible member.

In one avatar, the vehicle is a spacecraft or an Earth satellite.

### BRIEF DESCRIPTION OF THE DRAWING

FIG. 1 is a plot illustrating phase as a function of temperature for a coaxial cable and for a temperature-compensated optical fiber, both 2 meters (m) in length and operated at 4 GHz;

FIG. 2 is a plot illustrating phase as a function of temperature for a temperature-compensated optical fiber after short and long dwells at a given temperature, both with 2 m lengths and tested at 4 GHz;

FIG. 3 is a plot illustrating phase delay versus temperature for potted coax and optical fiber, both with 2 m lengths and operated at 4 GHz;

FIG. 4 is a simplified perspective or isometric view of a portion of a spacecraft or other vehicle including a temperature compensated optical fiber restrained to the vehicle body;

FIG. 5 is similar to FIG. 4, showing restraint of plural optical fibers;

FIG. 6a is a simplified perspective orisometric view of a vehicle body with a split-ring optical fiber restraint, and FIG. 6b is an axial view thereof;

FIG. 7a is a simplified elevation view of a split ring restraint with a movable closing device for closing the split, and FIG. 7b is similar, but uses a flexible hinge;

FIG. 8 is a simplfied elevation view of a vehicle body supporting a restraining ring or piece defining multiple optical-fiber-holding apertures; and

FIG. 9 is a plot illustrating the temperature response of two-meter sections of coaxial cable and temperature compensated optical fiber, both operated at 4 GHz and restrained in accordance with the invention, where the cables are subject to change of temperature at the rate of 1° C. per second.

### DESCRIPTION OF THE INVENTION

FIG. 1 illustrates a plot 10 of phase performance of a one-meter length of coaxial cable (coax), together with a plot 12 of the phase performance of a one-meter length of temperature-compensated optical fiber, both at 4 GHZ, over a temperature range extending from about −50° to +70° Celsius or Centigrade (C.). The measurements were made under temperature equilibrium conditions. Over the a temperature range of about −60° to +70° C., the phase of the coaxial cable varies by at least five degrees, while the optical fiber varies by much less than one degree. It will be appreciated that in many situations, RF signal paths for phase-sensitive applications may have lengths substantially exceeding one meter, and so the difference between the performance of the optical fiber over the coaxial cable for these applications will be larger.

It will be appreciated that the cables represented in the plots of FIG. 1 were tested under laboratory conditions, in which vibration and shock are not encountered. In actual use of such cables. especially on vehicles, shock and vibration are to be expected. As a result, the ordinary use of signal transmission cables, at least for vehicular use, or in uses where mechanical motions are involved, requires that the cables be attached to the structure of the vehicle to prevent excessive relative movement which might result in abrasion damage to the protective outer covering of the cables, or even to the transmission paths themselves. Various types of attachments are used to affix coaxial transmission lines or optical fibers (or their protective outer coverings, to be more exact) to each other or to the supporting body. In actual applications used in a spacecraft-type vehicle, potting material or clamps may be used at various locations along the lengths of the cables to provide the desired fixation.

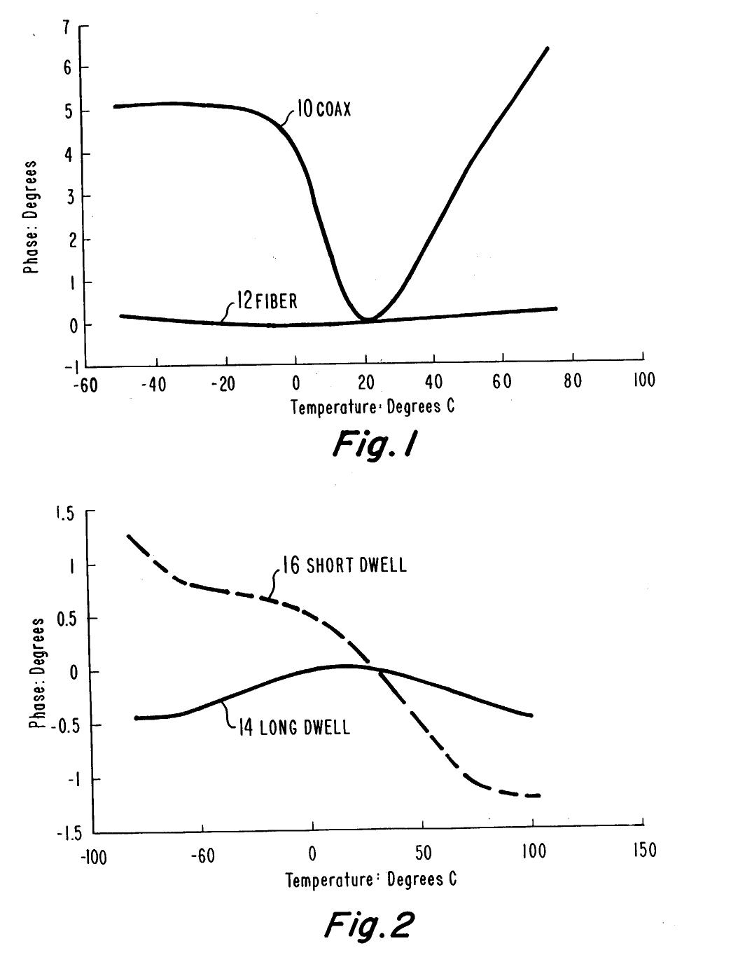

FIG. 2 illustrates plots of the phase performance of two-meter lengths of temperature-compensated optical fiber as a function of temperature, with dwell time as a parameter. FIG. 2 illustrates a plot 14 representing the phase delay of a two-meter length of temperature compensated optical fiber as a function of temperature, where the dwell time at the given temperature is fifteen minutes, and plot 16 is a plot of phase delay of the same optical fiber after a dwell time of less than only ten minutes. It will be noted that rapid temperature changes can substantially influence the phase delay even over short lengths of phase compensated optical fiber. Rapid changes in temperature are often encountered in vehicular operation, as the vehicle goes from direct sun into shade, or vice versa, and this is especially true in the case of Earth satellite vehicles. In FIG. 2, it will be apparent that the principal effect on phase delay occurs at relatively low temperatures, as for example below 0° C., in that the phase delay, even for moderate rates of temperature change, the phase delay continues to rise as the temperature drops. The faster the temperature change, the more pronounced the phase delay change. Similarly-shaped changes in phase delay occur in coaxial cables.

If the temperature of the optical fiber is allowed to stabilize after a rapid change, the phase delay will gradually relax toward the long-dwell plot 14.

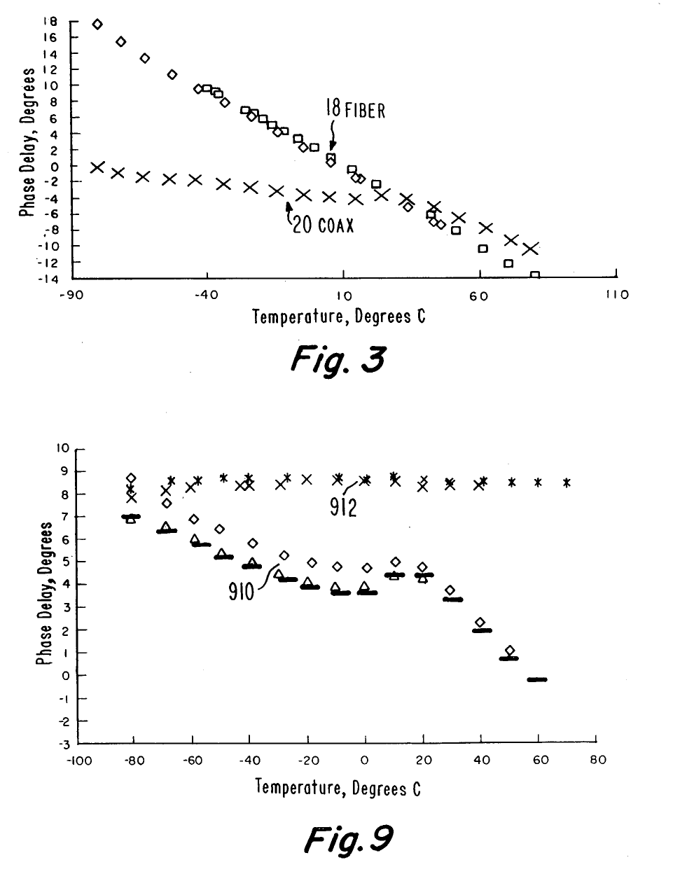

FIG. 3 illustrates plots of the phase delay of two-meter lengths of temperature-compensated optical fiber and coaxial cables completely potted in a silicone material, as a function of temperature, with rate of change of temperature as a parameter. In FIG. 3, plot 18 is for the optical fiber, and plot 20 is for coaxial cable. It will be seen that the plots 18 and 20 show a general trend which is substantially independent of the rate of change of temperature (that is, independent of the parameter), and the effect is more pronounced than in FIGS. 1 and 2. Only the actual temperature appears to affect such potted signal transmission paths. Similar results have been found through firm mechanical clamping all along the fiber. The temperature compensated optical fiber is clearly superior to the coaxial cable for low rates of temperature change, but it appears that ordinary mounting techniques affect the performance of the optical fiber, especially under conditions of high rate of change of temperature.

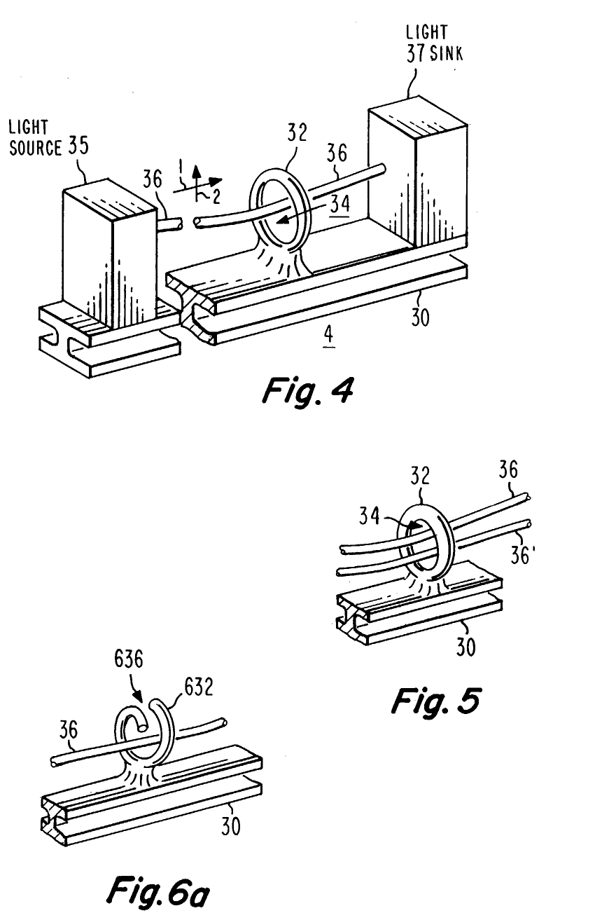

It has been discovered that suspension of the temperature-compensated optical fiber in a stress-free manner allows full recovery of its low phase delay variation properties even under conditions of very high rate of change of temperature. FIG. 4 is a simplified perspective or isometric view of a spacecraft vehicle 4 structure, represented by a portion 30 of an I-beam, with a rigid ring 32 affixed thereto. The structure may be that of a car, truck, ship, aircraft, or spacecraft. A temperature compensated optical fiber 36 extends between a source of information light illustrated as a box 35 to a sink of information light illustrated as a box 37, both of which are mounted to the spacecraft structure 30. Ring 32 has a central aperture 34 sufficiently large so that temperature compensated optical fiber 36 can be freely accommodated therein, without binding in the presence of any axial or small transverse motion (direction of arrows 1 and 2, respectively) of the fiber 36, as might be induced by thermal expansion. However, the presence of the ring prevents the fiber from leaving the confines of the aperture 34 by large transverse motion (in the direction of arrow 2). In effect, the fiber 36 is “fixed” against transverse motion, at least to the extent that the dimensions of the ring 32 limit its ability to migrate laterally. However, any axial motion which the optical fiber 36 makes under the impetus of temperature changes, or for any other reason, are unrestrained relative to the underlying structure 30. Naturally, a single optical fiber may be restrained by a fixing ring such as 32 at plural locations along its length.

When plural optical fibers are to be held in a bundle-like manner, plural optical fibers can be routed through one fixing ring, as suggested by FIG. 4. In FIG. 5, a vehicle structure 30 supports a fixing ring 32 through the central aperture 32 of which a bundle 536 of plural optical fibers 36, 36′ are routed. So long as the number of optical fibers is such that the diameter of the resulting bundle is sufficiently smaller than the diameter of the aperture 34 so that the optical fibers do not become “wedged in” or bound, the free axial motion of each fiber will be available, but the bundle of fibers 536 will be restrained as in the arrangement of FIG. 4. As in the case of a single fiber 36, the bundle 536 of fibers may be restrained at plural locations along its length, and optical fibers may enter andor leave the bundle at various locations, without the bundle losing its character as such.

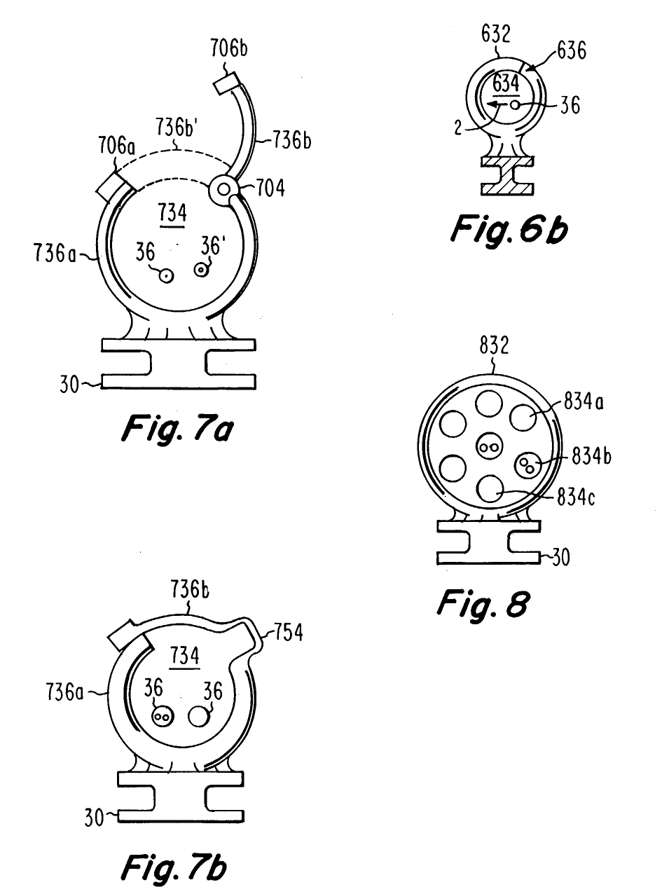

In order to avoid the need to thread each optical fiber through each fixing ring or restraint, the restraint may be split, as suggested in FIGS. 6a and 6b. FIG. 6a is a simplified perspective or isometric view of a split-ring restraint, and FIG. 6b is an axial view thereof. In FIGS. 6a and 6b, the optical fiber 36 can be placed within the “aperture” 634 by simply turning the optical fiber from its axial direction and laying the optical fiber alongside the split 636 in the ring 632, slipping the fiber through the slit and into the ring, and turning the optical fiber back to its original axial direction. While described for a single optical fiber, the same can be done with plural optical fibers in order to restrain a bundle of fibers. Multiple-turn restraints of the same sort are possible, with increased reliability against inadvertent excape of the fiber being weighed against ease of insertion of a partial-turn-split ring such as that of FIGS. 6a and 6b.

FIG. 7a illustrates another possible type of restraint which allows easy capturing of an optical fiber or a bundle of fibers. In FIG. 7a, the ring is composed of two portions, a part-ring 736a together with a hinged part-ring 736b. Part-ring 736b is hinged at 704, so that it can swivel to complete the ring, as suggested by phantom lines 736b′. Any conventional type of latch or fastening (e.g. VELCRO) can be used to lock the two parts of the ring together. The two portions of the fastening arrangement are illustrated as blocks 706a and 706b. A similar arrangement could be obtained by using a flexible material instead of a hinge. FIG. 7b illustrates a similar arrangement in which the hinge 754 is monolithically integral with the two body portions 736a and 736b, and due to its thin dimensions is sufficiently flexible to constitute a hinge.

FIG. 8 illustrates a ring 832 affixed to a vehicle body 30, where ring 832 includes or defines multiple apertures 834a, 834b, 834c . . . . Each aperture may restrain one optical fiber or a bundle of optical fibers, all without binding, of course.

The stress-free restraint of optical fibers in a vehicular environment allows the optical fiber to achieve its inherent phase delay notwithstanding temperature variations, even of high rate of change, or to put it another way, prevents excessive degradation of the inherent phase delay of an optical fiber as a function of temperature. When the phase delay of the optical fiber is inherently superior to ordinary fiber, as in the case of Sumitomo temperature-compensated optical fiber, the advantages of stress-free restraint according to the invention are greater than for ordinary fiber, because the underlying stability of phase variation with temperature is better. Especially for vehicles subjected to extremes of temperature variation, as is the case with some aircraft and with Earth satellites or spacecraft, the advantages are also very great, because the restraint is inherently low in weight, and may be even lower than that provided by methods such as potting, which provide lesser performance.

FIG. 9 plots the phase delay aat 4 GHz of a two-meter length of temperature-compensated optical fiber and that of a like length of coaxial cable, both supported in a stress-free manner according to the invention, and subjected to rates of temperature change of 1° Centigrade per second. In FIG. 9, the plot identified by squares and triangles, and designated 910, represents the phase delay of the coaxial cable, while the plot designated 912 represents the optical fiber. As can be seen the coaxial cable plot 910 changes as a function of temperature, while the plot of the phase delay of the optical fiber is essentially flat at about 8½ degrees. Thus, the optical fiber, when suspended or restrained according to the invention, provides much improved phase delay versus temperature performance, even at high rate of temperature change.

Other embodiments of the invention will be apparent to those skilled in the art. For example, while various types of vehicles have been described for use with the invention, other types subject to temperature changes may be used. While principally intended for vehicular use because of the likelihood of encountering temperature variations, the invention could also be used with a fixed installation which may be subject to temperature variations. While the descriptions have been of circular “rings” and apertures, those skilled in the art will understand that they may be oval, square, or irregularly shaped, as can their apertures, without departing from the spirit of the invention.

Thus, a vehicle according to an aspect of the invention includes a structural body (30), a first source (35) of light information signal mounted to the body (30), and a first sink (37) of light information signal mounted to the body (30) at a location remote from the first source (35) of light information. An optical fiber light transmission path (36) extends from the first source (35) of light information signal to the first sink (37) of light information signal, for carrying the information signal from the first source (35) to the first sink (37). If the optical fiber light transmission path (36) were not restrained, it might assume a stance or positioning which would route the optical fiber light transmission path (36) through a region in which its presence might interfere with other devices. A fiber restraint (32, 632, 736a,b, 832) is mechanically coupled to the vehicle body (30) at a selected location to which the optical fiber light transmission path (36) should be restrained, with the optical fiber restraint (32, 632, 736a,b,832) substantially surrounding the optical fiber light transmission path (36) in such a fashion that the optical fiber light transmission path (36) is restrained against large lateral movements (2), but not longitudinal movement (1). or small trasverse expansion (2)

In a particular embodiment of the invention, the restraint (32, 632, 736a,b,832) is in the form of a ring having a body defining an interior clearance aperture sufficient to allow the optical fiber to slide therethrough longitudinally or expand transversely or rotate without significant resistance, but wherein the presence of the body of the ring (32, 632, 736a,b,832) limits large lateral movement (2) of the optical fiber (36). Plural optical fibers (36, 36′) may be accommodated within one ring. The ring may be generally round. The ring may be split (636, 736a,b) so that the optical fiber can be easily laid therein, and the split may be closed by a closing member (736b′) to prevent any possible release of the fiber(s).

In one avatar, the vehicle is a spacecraft or an Earth satellite.

What is claimed is:

1. A vehicle, comprising:
a structural body:
a first source of light information signal, said first source being mounted to said body;
a first sink of light information signal, said first sink of light information signal being mounted to said body at a location remote from said first source of light information;
an optical fiber light transmission path extending from said first source of light information signal to said first sink of light information signal for carrying said information signal from said first source to said first sink whereby, if said optical fiber light transmission path is not restrained, it may assume a stance established by its own internal stresses, which stance may route said optical fiber light transmission path through a region in which its presence might interfere with other devices; and
a fiber restraint mechanically coupled to said body at a selected location to which said optical fiber light transmission path should be restrained, said fiber restraint substantially surrounding said optical fiber light transmission path in such a fashion that said optical fiber light transmission path is restrained against large lateral movement, but not against at least one of longitudinal movement, rotation or small lateral expansion.

2. A vehicle according to claim 1, wherein said restraint is in the form of a ring having a body defining an interior clearance aperture sufficient to allow said optical fiber to at least one of slide therethrough longitudinally, rotate, or expand laterally without significant resistance, but wherein the presence of said body of said ring limits lateral movement of said optical fiber.

3. A vehicle according to claim 2, wherein said clearance aperture of said body of said ring accommodates and laterally restrains plural optical fibers.

4. A vehicle according to claim 2, wherein said ring is generally round.

5. A vehicle according to claim 1, wherein said restraint is in the form of a split ring having a body defining an interior clearance aperture sufficient to allow said optical fiber to slide therethrough longitudinally without significant resistance, but wherein the presence of said body of said ring limits lateral movement of said optical fiber, and said split in said ring allows said optical fiber to be accommodated within said aperture without the need to thread said optical fiber through the aperture.

6. A vehicle according to claim 5, wherein said ring is bent to a nonplanar form.

7. A vehicle according to claim 5, wherein said restraint is defined by a movable element which moves relative to a fixed element to define said aperture in a closed position of said movable element.

8. A vehicle according to claim 6, wherein said restraint comprises a movable hinge.

9. A vehicle according to claim 6, wherein said restraint comprises a flexible, hinge-like member allowing said motion relative to said fixed element.

10. A spacecraft, comprising:
a structural body:
a first source of light information signal, said first source being mounted to said body;
a first sink of light information signal, said first sink of light information signal being mounted to said body at a location remote from said first source of light information;
an optical fiber light transmission path extending from said first source of light information signal to said first sink of light information signal for carrying said information signal from said first source to said first sink whereby, if said optical fiber light transmission path is not restrained, it may assume a stance established its own internal stresses, which stance may route said optical fiber light transmission path through a region in which its presence might interfere with other devices; and
a fiber restraint mechanically coupled to said body at a selected location to which said optical fiber light transmission path should be restrained, said fiber restraint substantially surrounding said optical fiber light transmission path in such a fashion that said optical fiber light transmission path is restrained against large lateral movement, but not restrained against at least one of longitudinal movement, lateral expansion, or rotation.
